(19) United States
(12) Patent Application Publication
(10) Pub. No.: US 2025/0182260 A1
(43) Pub. Date: Jun. 5, 2025

(54) DEVICE AND METHOD FOR GENERATING DEFECTIVE IMAGE

(71) Applicant: Electronics and Telecommunications Research Institute, Daejeon (KR)

(72) Inventor: Hyejin S. KIM, Daejeon (KR)

(73) Assignee: Electronics and Telecommunications Research Institute, Daejeon (KR)

(21) Appl. No.: 18/968,236

(22) Filed: Dec. 4, 2024

(30) Foreign Application Priority Data
Dec. 5, 2023 (KR) 10-2023-0174671
Dec. 2, 2024 (KR) 10-2024-0176881

(51) Int. Cl. G06T 7/00; G06T 5/77

(52) U.S. Cl. CPC G06T 7/0002; G06T 5/77

(57) ABSTRACT

Provided are a device and method for generating a defect image. The device includes a memory configured to store a plurality of normal patterns with different sizes and a plurality of defect patterns and a processor configured to generate a layout image including at least one layout, generate a composite image by acquiring at least one normal pattern corresponding to a physical feature of each layout of the layout image from the memory, and generate a defect image by integrating at least one defect pattern with the composite image.

### CROSS-REFERENCE TO RELATED APPLICATION

This application claims priority to and the benefit of Korean Patent Application Nos. 10-2023-0174671 and 10-2024-0176881, filed on Dec. 5, 2023 and Dec. 2, 2024, the disclosure of which is incorporated herein by reference in its entirety.

### BACKGROUND

### 1. Field of the Invention

The present invention relates to a device and method for generating a defective image.

### 2. Discussion of Related Art

In various industrial environments, such as semiconductor manufacturing, various studies are underway to improve manufacturing yields through the acquisition of manufacturing defect data.

To identify whether there is a defect, defect images that may be generated during manufacturing (production) processes are acquired, and the acquired defect images are used for training an artificial intelligence model.

However, in many cases, defect data based on real-world industrial environments is difficult to acquire for reasons such as security and a decline in production. In other words, since it is difficult to acquire defect images in industrial environments due to the low incidence of product defects, various methods have been proposed to acquire defect images. For example, defect images are generated using computer graphics or a simulation-based method.

Here, computer graphics and the simulation-based method require significant time and resources for high-quality three-dimensional (3D) modeling, and it is difficult to completely imitate actual environments.

### SUMMARY OF THE INVENTION

The present invention is directed to providing a defect image generation device and method for generating various types of defect images using a small number of defect patterns.

According to an aspect of the present invention, there is provided a device for generating a defect image, the device including a memory configured to store a plurality of normal patterns with different sizes and a plurality of defect patterns and a processor configured to generate a layout image including at least one layout, generate a composite image by acquiring at least one normal pattern corresponding to a physical feature of each layout of the layout image from the memory, and generate a defect image by integrating at least one defect pattern with the composite image.

The processor may generate the plurality of normal patterns on the basis of a normal image obtained by photographing a normal mask pattern and store the plurality of generated normal patterns in the memory.

The processor may extract one or more pixel-unit patterns from the normal image, generate one or more region-unit patterns by combining a plurality of pixel-unit patterns among the extracted pixel-unit patterns, and generate the one or more pixel-unit patterns and the one or more region-unit patterns as the normal patterns.

When layout information including at least one of physical features, a number, sizes, and directions of layouts is input, the processor may generate the layout image including one or more layouts in accordance with the layout information.

The processor may acquire at least one normal pattern between a region-unit pattern and a pixel-unit pattern corresponding to the physical feature of each layout included in the layout image from the memory and generate the composite image by inpainting the corresponding layout using the acquired normal pattern.

The processor may generate the defect image by inpainting at least one position in the composite image using the at least one defect pattern.

The processor may generate ground truth (GT) data for training using the position which is inpainted using the defect pattern.

According to another aspect of the present invention, there is provided a method of generating a defect image, the method including generating, by a processor, a layout image including at least one layout, generating, by the processor, a composite image by integrating at least one normal pattern corresponding to a physical feature of each layout included in the layout image with the corresponding layout, and generating, by the processor, a defect image by integrating at least one defect pattern with the composite image.

The method may further include, before the generating of the layout image, generating, by the processor, a plurality of normal patterns on the basis of a normal image obtained by photographing a normal mask and storing the plurality of generated normal patterns in a memory.

The storing of the plurality of generated normal patterns may include extracting, by the processor, one or more pixel-unit patterns from the normal image, generating one or more region-unit patterns by combining a plurality of pixel-unit patterns among the extracted pixel-unit patterns, and generating the one or more pixel-unit patterns and the one or more region-unit patterns as the normal patterns.

The generating of the layout image may include, when layout information including at least one of physical features, a number, sizes, and directions of layouts is input, generating, by the processor, the layout image including one or more layouts in accordance with the layout information.

The generating of the composite image may include acquiring, by the processor, at least one normal pattern between a region-unit pattern and a pixel-unit pattern corresponding to the physical feature of each layout included in the layout image from the memory and generating the composite image by inpainting the corresponding layout using the acquired normal pattern.

The generating of the defect image may include generating, by the processor, the defect image by inpainting at least one position in the composite image using the at least one defect pattern.

The generating of the defect image may include generating, by the processor, GT data for training using the position which is inpainted using the defect pattern.

According to another aspect of the present invention, there is provided a method of generating a defect image, the method including generating, by a processor, a plurality of normal patterns on the basis of a normal image obtained by photographing a normal mask pattern and storing the plurality of generated normal patterns in a memory, generating, by the processor, a layout image including at least one layout, generating, by the processor, a composite image by acquiring at least one normal pattern corresponding to a physical feature of each layout included in the layout image from the memory, and generating, by the processor, a defect image by integrating at least one defect pattern with the composite image.

The generating of the layout image may include, when layout information including at least one of physical features, a number, sizes, and directions of layouts is input, generating, by the processor, the layout image including one or more layouts in accordance with the layout information.

The generating of the composite image may include acquiring, by the processor, at least one normal pattern between a region-unit pattern and a pixel-unit pattern corresponding to the physical feature of each layout included in the layout image from the memory and generating the composite image by inpainting the corresponding layout using the acquired normal pattern.

The generating of the defect image may include generating, by the processor, the defect image by inpainting at least one position in the composite image using the at least one defect pattern.

The generating of the defect image may include generating, by the processor, GT data for training using the position which is inpainted using the defect pattern.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a schematic block diagram of a device for generating a defect image according to an exemplary embodiment of the present invention;

FIGS. 2 and 3 are example diagrams illustrating pixel-unit patterns according to an exemplary embodiment of the present invention;

FIG. 4 is an example diagram illustrating region-unit patterns according to an exemplary embodiment of the present invention;

FIGS. 5 and 6 are example diagrams illustrating layout images according to an exemplary embodiment of the present invention;

FIG. 7 is a flowchart illustrating a method of generating a defect image according to an exemplary embodiment of the present invention;

FIG. 8 is a flowchart illustrating a method of generating a defect image in the medical field according to an exemplary embodiment of the present invention; and

FIG. 9 is a flowchart illustrating a method of generating a defect image in the three-dimensional (3D) printing field according to an exemplary embodiment of the present invention.

### DETAILED DESCRIPTION OF EXEMPLARY EMBODIMENTS

Hereinafter, a device and method for generating a defect image according to exemplary embodiments of the present invention will be described with reference to the accompanying drawings. In this process, the thicknesses of lines, the sizes of components, and the like shown in the drawings may be exaggerated for the purpose of clarity and convenience of description. Also, terms used herein are defined in consideration of functions in the present invention, and the terms may vary depending on the intention of a user or operator or precedents. Therefore, these terms are to be defined on the basis of the overall content of the specification.

In manufacturing environments, images of products have very simple textures compared to everyday images, making texture-based learning difficult. Also, in manufacturing environments, it is difficult to acquire defect images (abnormality data) compared to normal images (normality data), which leads to data imbalance problems. In particular, in environments related to semiconductors, mask patterns of semiconductors are highly confidential corporate information and thus even more difficult to obtain.

To overcome this, defect images have been recently generated using image data augmentation methods, deep learning-based methods employing generative adversarial networks (GANs) or diffusion models, and the like.

However, it is difficult to acquire defect images due to low incidence of defects in manufacturing environments, which leads to difficulty in generating defect images using an image data augmentation method or a deep learning-based method.

Accordingly, the present invention proposes a technology for generating various types of defect images using a small number of defect (abnormality) data.

The present invention relates to a technology for easily generating various types of defect images (abnormality data) and accurately generating ground truth (GT) data for training in manufacturing environments.

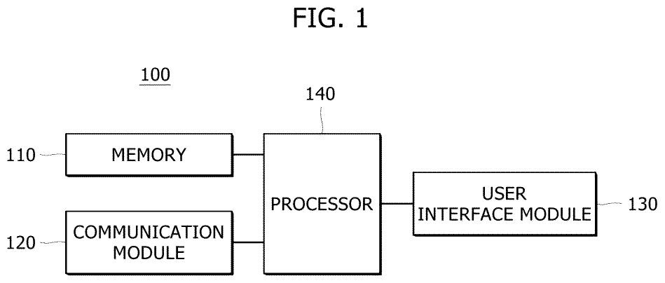

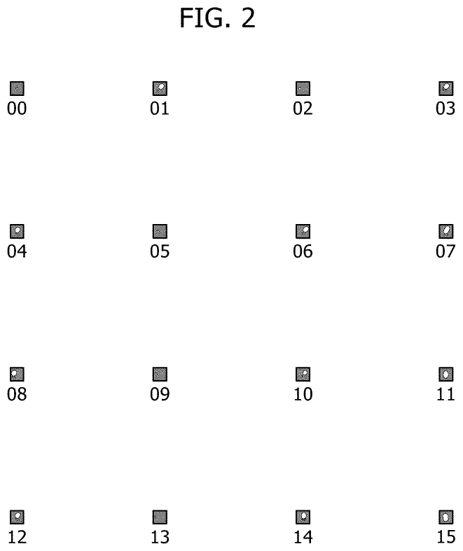

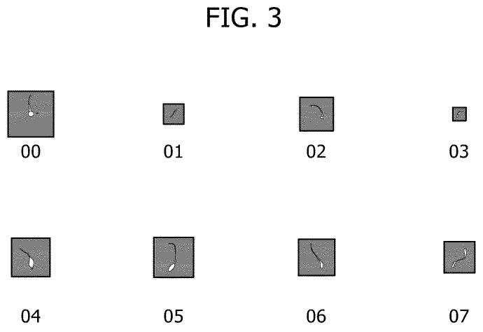

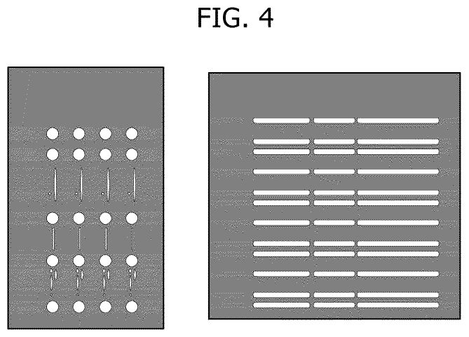

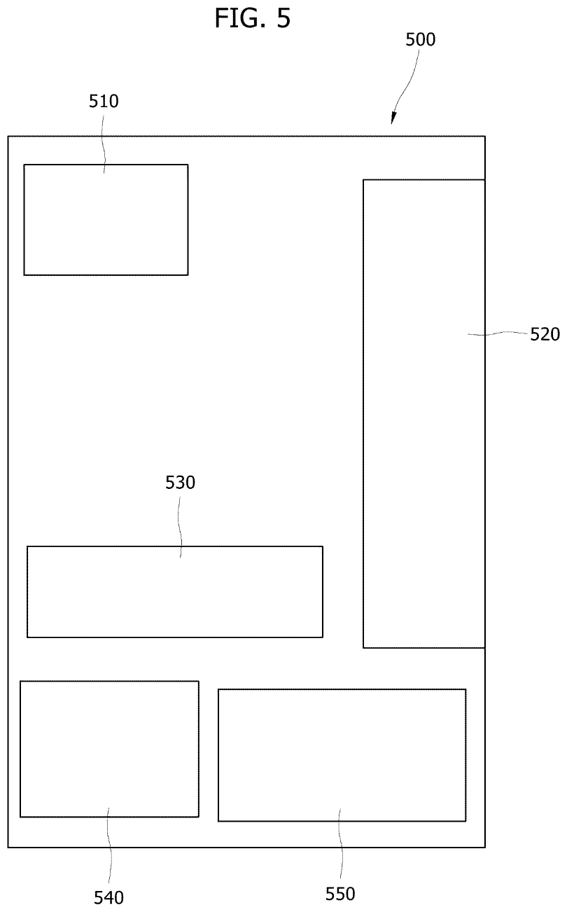

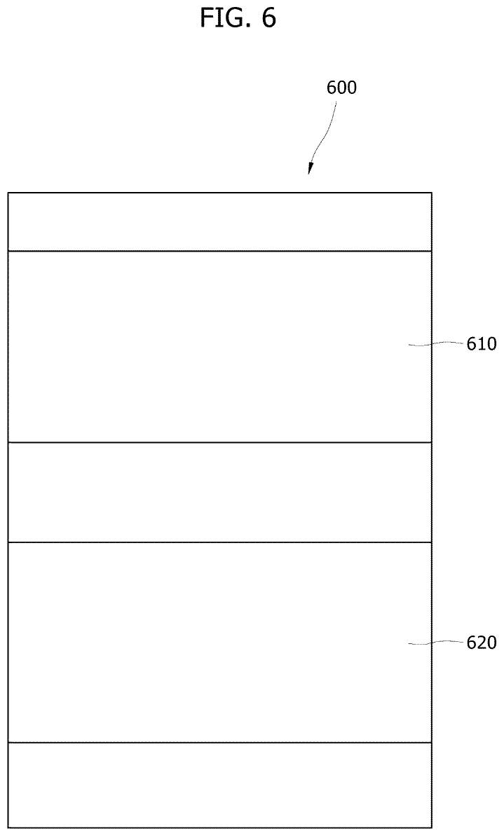

FIG. 1 is a schematic block diagram of a device for generating a defect image according to an exemplary embodiment of the present invention, FIGS. 2 and 3 are example diagrams illustrating pixel-unit patterns according to an exemplary embodiment of the present invention, FIG. 4 is an example diagram illustrating region-unit patterns according to an exemplary embodiment of the present invention, and FIGS. 5 and 6 are example diagrams illustrating layout images according to an exemplary embodiment of the present invention.

Referring to FIG. 1, a device 100 for generating a defect image according to an exemplary embodiment of the present invention may include a memory 110, a communication module 120, a user interface module 130, and a processor 140.

The memory 110 is an element that stores data related to operations of the device 100 for generating a defect image. In particular, the memory 110 may store a program (application or applet) for generating a normal pattern including at least one of a pixel-unit pattern and a region-unit pattern from a normal image, a program (application or applet) for generating a layout image, a program (application or applet) for generating a composite image by inpainting a layout image using a normal pattern, a program (application or applet) for generating a composite image by inpainting a composite image using at least one defect pattern, and the like, and the stored information may be selected by the processor 140 as necessary. The memory 110 may store pixel-unit patterns and region-unit patterns generated by the processor 140 as normal patterns. The memory 110 stores various types of data generated during the execution process of an operating system (OS) or program (application or applet) for running the device 100 for generating a defect image. In particular, the memory 110 may store a plurality of normal patterns and a plurality of defect patterns. Here, the memory 110 is a collective term of non-volatile storage devices that continuously maintain stored information without power supply and volatile storage devices that require power to maintain stored information.

The communication module 120 may provide an interface required for providing signals transmitted and received between the device 100 for generating a defect image and an external device in the form of packet data through a communication network. In particular, the communication module 120 may transmit and receive various information such as normal images (normal data), layout information, defect images (defect data), and the like. Also, the communication module 120 may be a device including hardware and software required for transmitting and receiving a signal, such as a control signal or a data signal, with another network device through a wired or wireless connection. Further, the communication module 120 may be implemented in various forms such as a short-range communication module, a wireless communication module, a mobile communication module, a wired communication module, and the like.

The user interface module 130 is an element that receives an input for controlling the device 100 for generating a defect image or output information related to operations of the device 100 for generating a defect image, and may be configured as any one of various types of devices such as a microphone, a mouse, a keyboard, a digital pen (e.g., a stylus pen), a speaker, a touchscreen, a display, a hologram device, a projector, and the like. The user interface module 130 may operate as an input device or output device.

While an embodiment of the present invention describes the user interface module 130 as having an integrated input and output device, an input device and an output device may be separately implemented as the user interface module 130.

The processor 140 may be configured to control overall operations of the device 100 for generating a defect image. The processor 140 may run the OS or application to control a plurality of hardware or software components connected to the processor 140 and perform various data processing and computations. The processor 140 may load an instruction or data received from at least one of other components to the memory 110, process the instruction or data, and store various data in the memory 110. The processor 140 may be implemented as, but is not limited to, an application specific integrated circuit (ASIC), a digital signal processor (DSP), a programmable logic device (PLD), field programmable gate arrays (FPGAs), a central processing unit (CPU), a microcontroller, a microprocessor, and/or the like.

The processor 140 may generate a plurality of normal patterns on the basis of a normal image obtained by photographing a normal mask pattern, generate a layout image including at least one layout, generate a composite image by integrating at least one normal pattern with each layout of the layout image, and generate a defect image by integrating at least one defect pattern with the composite image.

Operations of the processor 140 generating a defect image will be described in detail below.

A mask may be an original design for manufacturing a semiconductor device having a circuit pattern, that is, the design drawing of a semiconductor device pattern. Therefore, various patterns may be placed in masks, and a basic pattern is predetermined in a mask pattern. In other words, a basic pattern (circuit pattern) may be predetermined in a semiconductor device, and the predetermined basic pattern (circuit pattern) may be a core. The core (basic pattern) may vary in shape in accordance with an optical system. The core may include features, grids, standard cells, and the like. In semiconductor circuit design, a feature may be a fine pattern that is in charge of a specific electrical function. For example, features may include not only basic circuit elements, such as the gate, the source, and the drain of a transistor, but also a functional part such as interconnections. The size of a feature may vary in accordance with the size of a node in the design of a semiconductor circuit. Features may determine electrical characteristics of basic circuit elements, such as transistors, and electrical operations of the circuit may be determined by a feature arrangement. Grids may be reference frames for determining the positions of standard cells and features in a photomask design. Grids may be provided in the form of lines that are arranged at certain intervals in an XY plane, and may cause each cell to be accurately placed at a standard position. Grids may standardize the placement of each element and cause cells and features to be spaced at regular intervals. Standard cells are cells that define basic functional blocks frequently used in semiconductor design circuits, and may include, for example, a logic gate, a flip-flop, a latch, and the like. Standard cells may be placed on certain grids, and a power line and a ground line are placed at certain positions to ensure consistent connection. Since cores (basic pattern) include features, grids, standard cells, and the like, cores may have various shapes such as a circle, a quadrangle, a long line, a short line, and the like.

Accordingly, the processor 140 may generate various normal patterns ranging from the smallest unit pattern to the largest unit pattern that may become a core among patterns included in the normal image obtained by photographing the normal mask pattern. In other words, the processor 140 may generate a plurality of normal patterns on the basis of the normal image obtained by photographing the normal mask pattern.

Specifically, the processor 140 may extract one or more pixel-unit patterns from the normal image and generate the extracted pixel-unit patterns as normal patterns. Here, the processor 140 may extract at least one pixel-unit pattern that may be a core from the original or actual image. Also, the processor 140 may extract pixel-unit patterns including background information. In other words, the processor 140 may extract pixel-unit patterns, such as a pixel, a feature, and the like, from the original or actual image.

For example, the processor 140 may extract one pixel as a pixel-unit pattern as shown in FIG. 2. Also, the processor 140 may extract a plurality of pixels as a pixel-unit pattern as shown in FIG. 3.

The processor 140 may generate one or more region-unit patterns by combining a plurality of pixel-unit patterns. Here, the processor 140 may generate region-unit patterns in various sizes and directions using pixel-unit patterns. Region-unit patterns may be the smallest unit patterns in a pattern shape.

The processor 140 may generate region-unit patterns, such as grids, standard cells, and the like, using pixel-unit patterns. In other words, the processor 140 may generate functional blocks that are frequently used in a reference frame or a circuit for determining the positions of standard cells and features in a photomask design.

For example, as shown in FIG. 4, the processor 140 may generate region-unit patterns having various sizes and directions using pixel-unit patterns.

The processor 140 may store the pixel-unit patterns and the region-unit patterns in the memory 110 as normal patterns.

Meanwhile, the mask patterns of semiconductor elements may be classified as a plurality of layouts. Each layout is a form of distinguishing areas, such as segmentation, in an image and may have a different size and direction. Each layout may have a different physical function (operation or feature).

Accordingly, the processor 140 may randomly generate a layout image including layouts having various sizes and directions. In other words, when layout information about the physical features, the number, the sizes, and the directions of layouts is input, the processor 140 may generate a layout image in accordance with the layout information. The physical features of the layouts may be features acquired through data learning from expert information or features provided by inputs of individual experts. The layout image may be an image in which layouts having various sizes and directions are placed.

The processor 140 may receive a layout image including a variable number of layouts in various sizes and directions from a user. For example, a layout image of a semiconductor may include actual circuit components such as transistors, interconnections, and the like.

When a layout image is generated or a layout image is input from a user, the processor 140 may generate a composite image by combining a region-unit pattern and a pixel-unit pattern with each layout of the layout image. Here, the processor 140 may fill each layout with at least one of a region-unit pattern and a pixel-unit pattern using an inpainting technique.

In other words, the processor 140 may generate a composite image using a pattern inpainting technique of selecting a normal pattern corresponding to the feature of each layout to reflect the fact that features vary across layouts and filling the layout with the selected normal pattern. Here, the processor 140 may select a region-unit pattern and a pixel-unit pattern corresponding to the feature of each layout and inpaint the corresponding layout using the selected region-unit pattern and pixel-unit pattern to generate a composite image.

For example, a method of generating a composite image when a layout image 500 includes first, second, third, fourth, and fifth layouts 510, 520, 530, 540, and 550 having various sizes and directions as shown in FIG. 5, will be described below. It is assumed that the first layout 510 is about transistors, the second layout 520 is about a CPU, the third layout 530 is about D-flipflops, the fourth layout 540 is about AND gates, and the fifth layout 550 is about OR gates. In this case, the processor 140 may select a normal pattern (a region-unit pattern and a pixel-unit pattern) corresponding to the transistors of the first layout 510, a normal pattern (a region-unit pattern and a pixel-unit pattern) corresponding to the CPU of the second layout 520, a normal pattern (a region-unit pattern and a pixel-unit pattern) corresponding to the D-flipflops of the third layout 530, a normal pattern (a region-unit pattern and a pixel-unit pattern) corresponding to the AND gates of the fourth layout 540, and a normal pattern (a region-unit pattern and a pixel-unit pattern) corresponding to the OR gates of the fifth layout 550. After that, the processor 140 may inpaint the layouts 510 to 550 using the selected normal patterns.

A method of generating a composite image when a layout image 600 includes a first layout 610 and a second layout 620 as shown in FIG. 6 will be described below. In this case, the processor 140 may select a normal pattern (a region-unit pattern and a pixel-unit pattern) corresponding to the feature of a first layout 610 and a normal pattern (a region-unit pattern and a pixel-unit pattern) corresponding to the feature of a second layout 620 and inpaint the layouts 610 and 620 using the selected normal patterns.

When a composite image is generated, the processor 140 may generate a defect image by integrating at least one defect pattern with the composite image. Here, the processor 140 may integrate the at least one defect pattern with the composite image using an inpainting technique.

A defect may be a failure to form a normal pattern due to various factors such as external dust particles, abnormalities in processing equipment, byproducts of a manufacturing process, and the like. Therefore, defects may vary in size, but the patterns of defects may be determined in advance. In other words, various defect patterns may be set in advance and stored in the memory 110.

Accordingly, the processor 140 may generate a defect image by inpainting various positions in the composite image using various defect patterns. The processor 140 may accurately generate GT data for training using the positions inpainted using the defect patterns. Here, the GT data may be data indicating the position of a defect.

In this way, the processor 140 can not only easily generate defect images (abnormality data), which are insufficient in manufacturing environments, in various forms but also accurately generate training data with GT data.

Also, the processor 140 may generate various forms of defect images (abnormality data) even from defect information of a very few number of defect images (abnormality data and fault data).

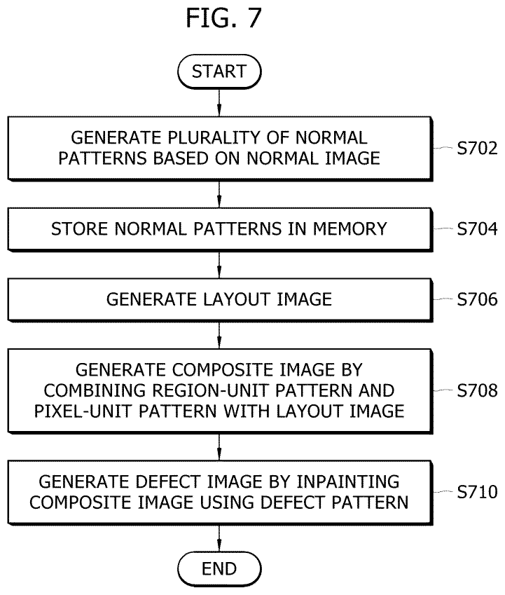

FIG. 7 is a flowchart illustrating a method of generating a defect image according to an exemplary embodiment of the present invention.

Referring to FIG. 7, the processor 140 generates a plurality of normal patterns on the basis of a normal image obtained by photographing a normal mask pattern (S702) and stores the generated normal patterns in the memory 110 (S704). Here, the normal patterns may include pixel-unit patterns, region-unit patterns, and the like. The processor 140 may extract one or more pixel-unit patterns from the normal image and generate the extracted pixel-unit patterns as normal patterns. The processor 140 may generate one or more region-unit patterns by combining a plurality of pixel-unit patterns. Here, the processor 140 may generate region-unit patterns in various sizes and directions using pixel-unit patterns.

After operation S704 is performed, when a layout image including layouts having various sizes and directions is generated or input (S706), the processor 140 generates a composite image by combining a region-unit pattern and a pixel-unit pattern with each layout of the layout image (S708). Here, when layout information including at least one of physical features, a number, sizes, and directions of layouts is input, the processor 140 may generate a layout image including one or more layouts in accordance with the layout information. After that, the processor 140 may integrate at least one of a region-unit pattern and a pixel-unit pattern with each layout using an inpainting technique. In other words, the processor 140 may generate a composite image using a pattern inpainting technique of selecting a normal pattern (a region-unit pattern and a pixel-unit pattern) corresponding to the feature of each layout to reflect the fact that features vary across layouts and filling the layout with the selected normal pattern (the region-unit pattern and the pixel-unit pattern).

When operation S708 is performed, the processor 140 generates a defect image by inpainting the composite image using at least one defect pattern (S710). Here, the processor 140 may generate a defect image by inpainting various positions in the composite image using various defect patterns. In this way, the processor 140 can accurately generate GT data for training using the positions inpainted using the defect patterns.

Only a process of generating a defect image using a normal image in a semiconductor manufacturing environment has been described above, but a defect image can be generated using a normal image in the medical field and three-dimensional (3D) printing field.

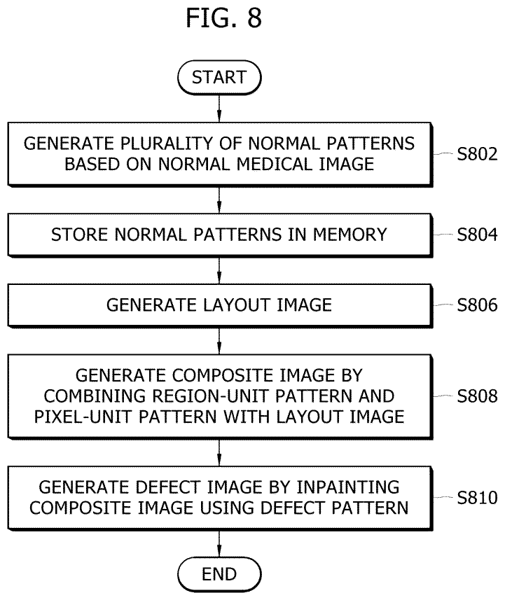

First, a method of generating a defect image using a normal medical image will be described below with reference to FIG. 8.

FIG. 8 is a flowchart illustrating a method of generating a defect image in the medical field according to an exemplary embodiment of the present invention.

Referring to FIG. 8, the processor 140 generates a plurality of normal patterns on the basis of a normal medical image obtained by photographing a normal pattern (S802) and stores the generated normal patterns in the memory 110 (S804). The processor 140 may generate various normal patterns ranging from the smallest unit pattern to the largest unit pattern that may become a core among patterns included in the normal image obtained by photographing the normal mask pattern. Here, the normal patterns may include pixel-unit patterns, region-unit patterns, and the like. The processor 140 may extract one or more pixel-unit patterns from the normal medical image and generate the extracted pixel-unit patterns as normal patterns. The processor 140 may generate one or more region-unit patterns by combining a plurality of pixel-unit patterns. Here, the processor 140 may generate region-unit patterns in various sizes and directions using pixel-unit patterns.

After operation S804 is performed, when a layout image including layouts having various sizes and directions is generated or input (S806), the processor 140 generates a composite image by combining a region-unit pattern and a pixel-unit pattern with each layout of the layout image (S808).

The medical image may be divided into a plurality of layouts (subregions). Each layout is a form for distinguishing an area, such as a segmentation, in the image, and each layout may have a different size and direction. Each layout may have a different physical feature (functional characteristic) (e.g., lungs, liver, cerebral cortex, cerebellum, or the like). Accordingly, when layout information including at least one of physical features, a number, sizes, and directions of layouts is input, the processor 140 may randomly generate a layout image including one or more layouts in accordance with the layout information. Here, the layout image may be an image in which layouts having various sizes and directions are placed. The processor 140 may receive a layout image including layouts having various sizes and directions from a user. When a layout image is generated or a layout image is input from a user, the processor 140 may integrate at least one of a region-unit pattern and a pixel-unit pattern with each layout using an inpainting technique. In other words, the processor 140 may generate a composite image using a pattern inpainting technique of selecting a normal pattern (a region-unit pattern and a pixel-unit pattern) corresponding to the feature of each layout to reflect the fact that features vary across layouts and filling the layout with the selected normal pattern (the region-unit pattern and the pixel-unit pattern).

When operation S808 is performed, the processor 140 generates a defect image by inpainting the composite image using at least one defect pattern (S810). Here, the processor 140 may generate a medical defect image by inpainting various positions in the composite image using various defect patterns. In this way, the processor 140 can accurately generate GT data for training using the positions inpainted using the defect patterns.

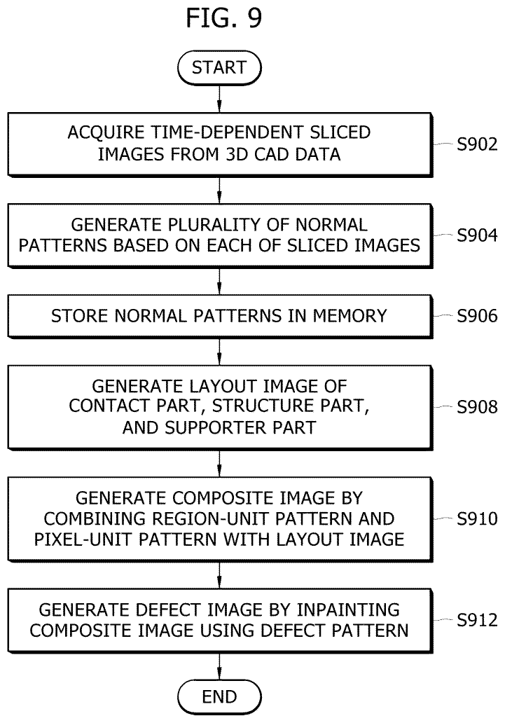

FIG. 9 is a flowchart illustrating a method of generating a defect image in the 3D printing field according to an exemplary embodiment of the present invention.

Referring to FIG. 9, the processor 140 acquires time-dependent sliced images from 3D computer-aided design (CAD) data (S902), generates a plurality of normal patterns on the basis of each of the sliced images (S904), and stores the generated normal patterns in the memory 110 (S906). Since the 3D CAD data is intended to print sliced data (sliced images) over time, the processor 140 may acquire time-dependent sliced data from the 3D CAD data. Here, the 3D CAD data and the sliced images may be normal images with normal patterns. The processor 140 may generate various normal patterns ranging from the smallest unit pattern to the largest unit pattern that may become a core among patterns included in the sliced images. Here, the normal patterns may include pixel-unit patterns, region-unit patterns, and the like. The processor 140 may extract one or more pixel-unit patterns from the sliced images and generate the extracted pixel-unit patterns as normal patterns. The processor 140 may generate one or more region-unit patterns by combining a plurality of pixel-unit patterns. Here, the processor 140 may generate region-unit patterns in various sizes and directions using pixel-unit patterns.

After operation S906 is performed, when layout images of each of a contact part, a structure part, and a supporter part are generated or input (S908), the processor 140 generates a composite image by combining a region-unit pattern and a pixel-unit pattern with each layout of the layout images (S910). Here, the processor 140 may generate layout images for each of the contact part, the structure part, and the supporter part using the sliced images. Specifically, when layout information including at least one of physical features, a number, sizes, and directions of layouts is input, the processor 140 may generate a layout image including one or more layouts in accordance with the layout information. After that, the processor 140 may integrate at least one of a region-unit pattern and a pixel-unit pattern with each layout using an inpainting technique. In other words, the processor 140 may generate a composite image using a pattern inpainting technique of selecting a normal pattern (a region-unit pattern and a pixel-unit pattern) corresponding to the feature of each layout to reflect the fact that features vary across layouts and filling the layout with the selected normal pattern (the region-unit pattern and the pixel-unit pattern).

When operation S910 is performed, the processor 140 generates a defect image by inpainting the composite image using at least one defect pattern (S912). Here, the processor 140 may generate a defect image by inpainting various positions in the composite image using various defect patterns. In this way, the processor 140 can accurately generate GT data for training using the positions inpainted using the defect patterns.

With a device and method for generating a defect image according to some embodiments of the present invention, a composite image is generated by inpainting each layout of a layout image using at least one normal pattern, a defect image is generated by inpainting various positions in the composite image using at least one defect pattern, and thus it is possible to generate various types of multiple defect images (abnormality data) even from at least one normal image and at least one defect image. In this way, it is possible to generate various types of defect images with little computational resources and data.

With a device and method for generating a defect image according to some embodiments of the present invention, a layout can be formed to include physical information that is difficult to contain through an image generation device according to the related art.

With a device and method for generating a defect image according to some embodiments of the present invention, it is possible to not only facilitate generation of various types of defect images (abnormality data), which are difficult to acquire in a manufacturing environment, but also accurately generate training data with GT data.

With a device and method for generating a defect image according to some embodiments of the present invention, it is possible to improve the performance of defect detection by generating multiple defect images.

Although the present invention has been described above with reference to embodiments illustrated in the drawings, the embodiments are merely illustrative, and 10 those of ordinary skill in the art should understand that various modifications and other equivalent embodiments can be made from the embodiments. Therefore, the technical scope of the present invention should be determined from the following claims.

What is claimed is:

1. A device for generating a defect image, the device comprising:
a memory configured to store a plurality of normal patterns with different sizes and a plurality of defect patterns; and
a processor configured to generate a layout image including at least one layout, generate a composite image by acquiring at least one normal pattern corresponding to a physical feature of each layout of the layout image from the memory, and generate a defect image by integrating at least one defect pattern with the composite image.

2. The device of claim 1, wherein the processor generates the plurality of normal patterns on the basis of a normal image obtained by photographing a normal mask pattern and stores the plurality of generated normal patterns in the memory.

3. The device of claim 2, wherein the processor extracts one or more pixel-unit patterns from the normal image, generates one or more region-unit patterns by combining a plurality of pixel-unit patterns among the extracted pixel-unit patterns, and generates the one or more pixel-unit patterns and the one or more region-unit patterns as the normal patterns.

4. The device of claim 1, wherein, when layout information including at least one of physical features, a number, sizes, and directions of layouts is input, the processor generates the layout image including one or more layouts in accordance with the layout information.

5. The device of claim 4, wherein the processor acquires at least one normal pattern between a region-unit pattern and a pixel-unit pattern corresponding to the physical feature of each layout included in the layout image from the memory and generates the composite image by inpainting the corresponding layout using the acquired normal pattern.

6. The device of claim 1, wherein the processor generates the defect image by inpainting at least one position in the composite image using the at least one defect pattern.

7. The device of claim 6, wherein the processor generates ground truth (GT) data for training using the position which is inpainted using the defect pattern.

8. A method of generating a defect image, the method comprising:
generating, by a processor, a layout image including at least one layout;
generating, by the processor, a composite image by integrating at least one normal pattern corresponding to a physical feature of each layout included in the layout image with the corresponding layout; and
generating, by the processor, a defect image by integrating at least one defect pattern with the composite image.

9. The method of claim 8, further comprising, before the generating of the layout image, generating, by the processor, a plurality of normal patterns on the basis of a normal image obtained by photographing a normal mask and storing the plurality of generated normal patterns in a memory.

10. The method of claim 9, wherein the storing of the plurality of generated normal patterns comprises extracting, by the processor, one or more pixel-unit patterns from the normal image, generating one or more region-unit patterns by combining a plurality of pixel-unit patterns among the extracted pixel-unit patterns, and generating the one or more pixel-unit patterns and the one or more region-unit patterns as the normal patterns.

11. The method of claim 9, wherein the generating of the layout image comprises, when layout information including at least one of physical features, a number, sizes, and directions of layouts is input, generating, by the processor, the layout image including one or more layouts in accordance with the layout information.

12. The method of claim 9, wherein the generating of the composite image comprises acquiring, by the processor, at least one normal pattern between a region-unit pattern and a pixel-unit pattern corresponding to the physical feature of each layout included in the layout image from the memory and generating the composite image by inpainting the corresponding layout using the acquired normal pattern.

13. The method of claim 9, wherein the generating of the defect image comprises generating, by the processor, the defect image by inpainting at least one position in the composite image using the at least one defect pattern.

14. The method of claim 13, wherein the generating of the defect image comprises generating, by the processor, ground truth (GT) data for training using the position which is inpainted using the defect pattern.

15. A method of generating a defect image, the method comprising:
generating, by a processor, a plurality of normal patterns on the basis of a normal image obtained by photographing a normal mask pattern and storing the plurality of generated normal patterns in a memory;
generating, by the processor, a layout image including at least one layout;
generating, by the processor, a composite image by acquiring at least one normal pattern corresponding to a physical feature of each layout included in the layout image from the memory; and
generating, by the processor, a defect image by integrating at least one defect pattern with the composite image.

16. The method of claim 15, wherein the generating of the layout image comprises, when layout information including at least one of physical features, a number, sizes, and directions of layouts is input, generating, by the processor, the layout image including one or more layouts in accordance with the layout information.

17. The method of claim 15, wherein the generating of the composite image comprises acquiring, by the processor, at least one normal pattern between a region-unit pattern and a pixel-unit pattern corresponding to the physical feature of each layout included in the layout image from the memory and generating the composite image by inpainting the corresponding layout using the acquired normal pattern.

18. The method of claim 15, wherein the generating of the defect image comprises generating, by the processor, the defect image by inpainting at least one position in the composite image using the at least one defect pattern.

19. The method of claim 18, wherein the generating of the defect image comprises generating, by the processor, ground truth (GT) data for training using the position which is inpainted using the defect pattern.
